(19) United States
(12) Patent Application Publication
(10) Pub. No.: US 2007/0223445 A1
(43) Pub. Date: Sep. 27, 2007

(54) Time synchronization apparatus and method of digital broadcasting reception terminal

(75) Inventor: Woo-Hyun Baek, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/726,595

(22) Filed: Mar. 22, 2007

(30) Foreign Application Priority Data
Mar. 24, 2006 (KR) 27040/2006

(51) Int. Cl. H04J 3/06

(52) U.S. Cl. 370/350; 370/503

(57) ABSTRACT

Disclosed is a time synchronization apparatus and method of a digital broadcasting reception terminal. A Time and Data Table (TDT) is extracted from Program Specific Information and Service Information contained in received digital broadcasting data, and current Universal Time Coordinated (UTC) time is calculated form the extracted TDT. Current local time, which is a correct time of a region where a digital broadcasting receiving terminal is currently located, is calculated by reflecting local time information on the calculated UTC time. Time information is set by synchronizing the calculated current local time with a Real Time Clock. Accordingly, since a user does not have to directly set an internal time of the digital broadcasting receiving terminal, troublesomeness due to the internal time setting can be solved, and a correct time of a region where the digital broadcasting receiving terminal is currently located can be set.

### PRIORITY

This application claims priority under 35 U.S.C. § 119 to an application entitled “Time Synchronization Apparatus and Method of Digital Broadcasting Reception Terminal” filed in the Korean Intellectual Property Office on Mar. 24, 2006 and assigned Serial No. 2006-27040, the contents of which are incorporated herein by reference.

### BACKGROUND OF THE INVENTION

1. Field of the Invention

The present invention relates generally to a digital broadcasting reception terminal, and, in particular, to an asynchronous digital broadcasting reception terminal capable of receiving a digital broadcast program.

2. Description of the Related Art

In general, digital broadcasting is a broadcasting service for providing high image quality, high sound quality, and a superior service to users by replacing conventional analog broadcasting. Various types of digital broadcasting exist, such as Digital Multimedia Broadcasting (DMB), Digital Audio Broadcasting (DAB), Digital Video Broadcasting (DVB), Media Forward Link Only (MediaFLO), and Digital Video Broadcasting-Handhelds (DVB-H).

A digital broadcasting station transmits Program Specific Information (PSI) and Service Information (SI) to digital broadcasting receiving terminals using an Electronic Program Guide (EPG) channel, and a digital broadcasting receiving terminal can receive DMB data according to a channel selected by a user by referring to the PSI and SI. Examples of PSI are a Program Association Table (PAT), a Program Map Table (PMT), and a Conditional Access Table (CAT), and examples of SI are a Service Description Table (SDT), a Network Information Table (NIT), an Event Information Table (EIT), a Time and Date Table (TDT), and a Broadcaster Information Table (BIT). Hereinafter, PSI and SI are collectively referred to as PSI/SI.

The SDT contains broadcasting service channels of a media channel being currently broadcasted and information on the broadcasting service channels, and a user can select a desired channel by referring to the SDT. The PAT contains identifications (IDs) of the broadcasting channels being currently broadcast and packet IDs (PIDs) of the PMT having additional information of the broadcasting channels, i.e., PMT PIDs which are PIDs of the broadcasting channels. The PMT contains PIDs of video and audio stream packets corresponding to PIDs of individual broadcasting channels, i.e., the PMT PIDs. The NIT contains information on current transmission networks of Satellite DMB (S-DMB). The EIT contains information on names, beginning times, and broadcasting durations of individual programs. The BIT contains information on broadcasting stations broadcasting the individual programs. The TDT contains information such as a current time and date.

Digital broadcasting receiving terminals having a mobile communication function by wireless connection to a mobile communication network besides a digital broadcasting receiving function have been available on the market. Among the digital broadcasting receiving terminals also having the mobile communication function, digital broadcasting receiving terminals connected to a synchronous mobile communication network, such as a Code Division Multiplex Access (CDMA) network, synchronize their own Real Time Clock (RTC) by receiving time information from a Base Transceiver Station (BTS) in which each of them is registered. Thus, a digital broadcasting receiving terminal connected to a synchronous mobile communication network always synchronizes its own RTC with time information of a region in which it is currently located. However, unlike the synchronous mobile communication network, an asynchronous mobile communication network, such as a Global System for Mobile Communication (GSM) network, does not provide time information for time synchronization. Thus, digital broadcasting receiving terminals connected to an asynchronous mobile communication network cannot receive correct time information from the asynchronous mobile communication network. Accordingly, users of the digital broadcasting receiving terminals connected to an asynchronous mobile communication network must manually match an internal time with a local time zone.

Thus, a conventional asynchronous digital broadcasting receiving terminal presents a problem that a user must directly set time information every time the conventional asynchronous digital broadcasting receiving terminal is reset. Since the user must manually perform time synchronization, the manually set time information of the digital broadcasting receiving terminal will not be correct if a clock referred to by the user is not correct, or if the user incorrectly sets the time information.

### SUMMARY OF THE INVENTION

An object of the present invention is to substantially solve at least the above problems and/or disadvantages and to provide at least the advantages below. Accordingly, an object of the present invention is to provide an apparatus and method for automatically setting a time in a digital broadcasting receiving terminal connectable to an asynchronous mobile communication network even when a user does not directly set the time.

Another object of the present invention is to provide an apparatus and method for correctly setting an internal time of a digital broadcasting receiving terminal connectable to an asynchronous mobile communication network.

According to one aspect of the present invention, there is provided a time synchronization apparatus of a digital broadcasting receiving terminal connected to an asynchronous mobile communication network, the apparatus including a Real Time Clock (RTC); a digital broadcasting receiver for receiving digital broadcasting data and extracting Time and Data Table (TDT) information containing current Universal Time Coordinated (UTC) information from the received digital broadcasting data; a memory unit for storing local time information, which indicates a difference between current local time of a region where the digital broadcasting receiving terminal is currently located and current UTC time; a time information calculator for calculating the current UTC time from the TDT information and extracting the current local time of the region, in which the digital broadcasting receiving terminal is currently located, by reflecting the local time information on the calculated current UTC time; and a controller for, if a pre-set time synchronization condition is satisfied, extracting the TDT information through the digital broadcasting receiver, loading the local time information, and outputting the loaded local time information and the extracted TDT information to the time information calculator, and if the current local time is extracted, synchronizing the extracted current local time with the RTC.

According to another aspect of the present invention, there is provided a time synchronization method of a digital broadcasting receiving terminal connected to an asynchronous mobile communication network, the method including receiving digital broadcasting data; determining whether a pre-set time synchronization condition is satisfied; if the time synchronization condition is satisfied, loading local time information, which indicates a difference between current Universal Time Coordinated (UTC) time and current local time of a region where the digital broadcasting receiving terminal is currently located; extracting Time and Data Table (TDT) information containing the UTC information from the received digital broadcasting data; calculating the current UTC time from the extracted TDT information; calculating the current local time of the region, in which the digital broadcasting receiving terminal is currently located, by reflecting the local time information on the calculated current UTC time; and synchronizing the extracted current local time with a Real Time Clock (RTC) of the digital broadcasting receiving terminal.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram of a digital broadcasting receiving terminal according to the present invention;

FIG. 2 is a flowchart illustrating a method of performing time synchronization in a digital broadcasting receiving terminal according to the present invention; and

FIG. 3 is a flowchart illustrating a method of selecting and loading time information depending on a currently located region in a digital broadcasting receiving terminal according to the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

In the present invention, a Time and Data Table (TDT) is extracted from Program Specific Information and Service Information (PSI/SI) contained in received digital broadcasting data, and current Universal Time Coordinated (UTC) time is calculated form the extracted TDT. Current local time, which is a correct time of a region where a digital broadcasting receiving terminal is currently located, is calculated by reflecting local time information on the calculated UTC time. Time information is set by synchronizing the calculated current local time with a Real Time Clock (RTC). Accordingly, in the present invention, since a user does not have to directly set an internal time of the digital broadcasting receiving terminal, troublesomeness due to the internal time setting can be solved, and furthermore, a correct time of a region where the digital broadcasting receiving terminal is currently located is automatically set.

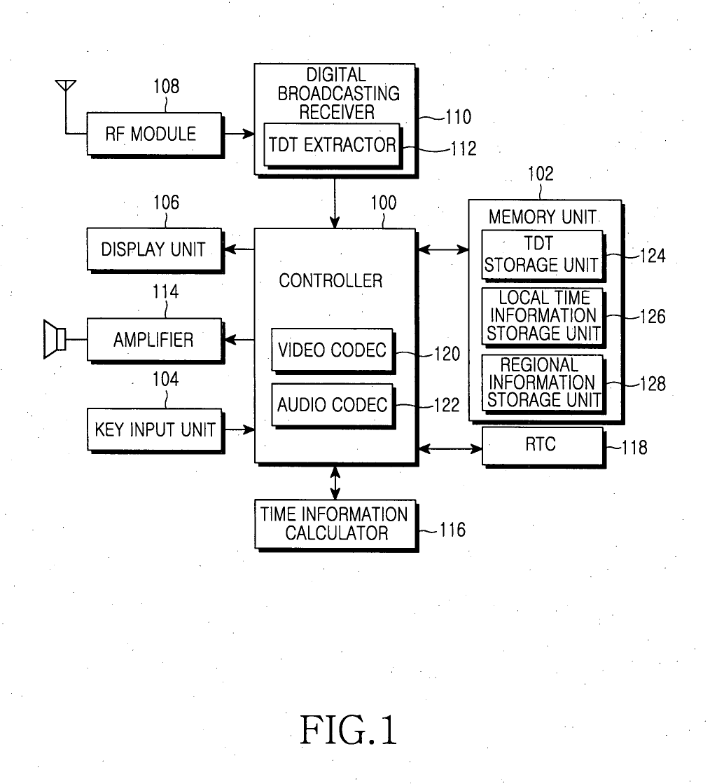

FIG. 1 is a block diagram of a digital broadcasting receiving terminal according to the present invention. Referring to FIG. 1, the digital broadcasting receiving terminal includes a controller 100 and a memory unit 102, a key input unit 104, a display unit 106, a digital broadcasting receiver 110, an amplifier 114, a time information calculator 116, and a RTC 118, which are connected to the controller 100. The RTC 118 is a device for generating a pulse at a predetermined time interval, i.e., a clock providing a correct time to the digital broadcasting receiving terminal.

The controller 100 performs a mobile communication function according to a protocol for a phone call, data communication, or a wireless Internet access and processes a speech signal and data according to a protocol for digital broadcasting. The controller 100 also controls components of the digital broadcasting receiving terminal. The controller 100 also receives PSI/SI and digital broadcasting data from the digital broadcasting receiver 110.

If a user selects an option to view a digital broadcasting program, the controller 100 decodes the received digital broadcasting data to an audio signal and a video signal using an audio codec 122 and a video codec 120 and outputs the decoded audio signal and the decoded video signal to the amplifier 114 and the display unit 106, respectively. The controller 100 receives a key input of the user from the key input unit 104 and controls the display unit 106 according to the key input so that image information according to the key input is provided to the user.

If a time synchronization condition is satisfied, the controller 100 extracts TDT information from the received PSI/SI and calculates current UTC time from the extracted TDT information. The time synchronization condition can be variously set according to a selection of the user. For example, the time synchronization condition may be set to when the digital broadcasting receiving terminal is turned on so that the digital broadcasting receiving terminal can receive digital broadcasting data or when the user sets a predetermined period for repeatedly performing the time synchronization.

When the current UTC time is calculated, the controller 100 calculates current local time information by reflecting local time information on the calculated current UTC time. The local time may be time information pre-stored since the digital broadcasting receiving terminal was put on the market or one of a plurality of pieces of time information according to various regions in the world, which were pre-stored in the memory unit 102. For the latter, if the time synchronization condition is satisfied, the controller 100 receives regional information according to a region, in which the digital broadcasting receiving terminal is currently located, from a currently connected asynchronous mobile communication network, i.e., a Base Transceiver Station (BTS) of the currently connected asynchronous mobile communication network. The controller 100 may use one of the plurality of pieces of time information pre-stored according to the regions corresponding to the received regional information as local time information of a current region. The local time information indicates time differences according to regions, i.e., a time difference between the UTC time and each local time according to regions in the world.

If the local time information of the current region is loaded, the controller 100 calculates a correct time (hereinafter, current local time) according to the region in which the digital broadcasting receiving terminal is currently located by reflecting the loaded local time information on the current UTC time and sets an internal time of the digital broadcasting receiving terminal by synchronizing the calculated current local time with the RTC 118.

The memory unit 102 connected to the controller 100 includes an area for storing the TDT information extracted from the digital broadcasting data and an area for storing the local time information. Hereinafter, the area for storing the TDT information is called a TDT storage unit 124, and the area for storing the local time information is called a local time information storage unit 126. The local time information may be the former local time information pre-stored since the digital broadcasting receiving terminal was put on the market or may be the latter information on time differences between the UTC time and local times according to regions in the world.

For the former, time information according to a region in which the digital broadcasting receiving terminal is put on the market is generally stored as the local time information. However, the stored local time information can be modified by downloading local time information via an asynchronous mobile communication network. For the latter, instead of that time information of only a region is stored, time differences between the UTC time and local times of regions are stored as a plurality of pieces of time information according to regions. The controller 100 selects one of the plurality of pieces of time information according to regions as the local time information based on the regional information received from the BTS of the currently connected asynchronous mobile communication network. In this case, the memory unit 102 further includes a regional information storage unit 128 for storing the regional information, as illustrated in FIG. 1. The regional information may be stored in a Subscriber Identity Module (SIM) card (not shown). In this case, the regional information storage unit 128 may be the SIM card.

The key input unit 104 includes various kinds of keys including numeric keys as described above and provides a key input signal corresponding to a key selected by the user to the controller 100. The display unit 106 converts the decoded video data input from the controller 100 to image information and outputs the converted image information. The amplifier 114 is connected to a speaker and outputs the decoded audio data input from the controller 100 to the speaker. The amplifier 114 amplifies an audio signal that is to be output to the speaker, and the volume of the speaker is controlled by the controller 100.

The digital broadcasting receiver 110 receives digital broadcasting data broadcasted by a digital broadcasting station through a Radio Frequency (RF) module 108 connected thereto. The digital broadcasting receiver 110 divides the received digital broadcasting data into data of transmission channels, i.e., an EPG channel, a multimedia channel, and a control channel. If a specific broadcasting channel is selected through the controller 100, the digital broadcasting receiver 110 sets information on the selected broadcasting channel in the RF module 108 so that only digital broadcasting data according to the set broadcasting channel is received from among data received through the multimedia channel. The digital broadcasting receiver 110 includes a TDT extractor 112 to extract TDT information from PSI/SI received through the EPG channel and outputs the extracted TDT information to the controller 100.

The RF module 108 includes a baseband processing unit (not shown) to receive digital broadcasting data broadcasted by digital broadcasting stations. The RF module 108 receives only digital broadcasting data according to a broadcasting channel set by the user, via the multimedia channel. The time information calculator 116 receives the TDT information from the controller 100 and calculates a current UTC time. If local time information is received from the controller 100, the time information calculator 116 calculates a correct time according to a region, in which the digital broadcasting receiving terminal is currently located, by reflecting the received local time information on the calculated current UTC time and returns the calculated correct time to the controller 100.

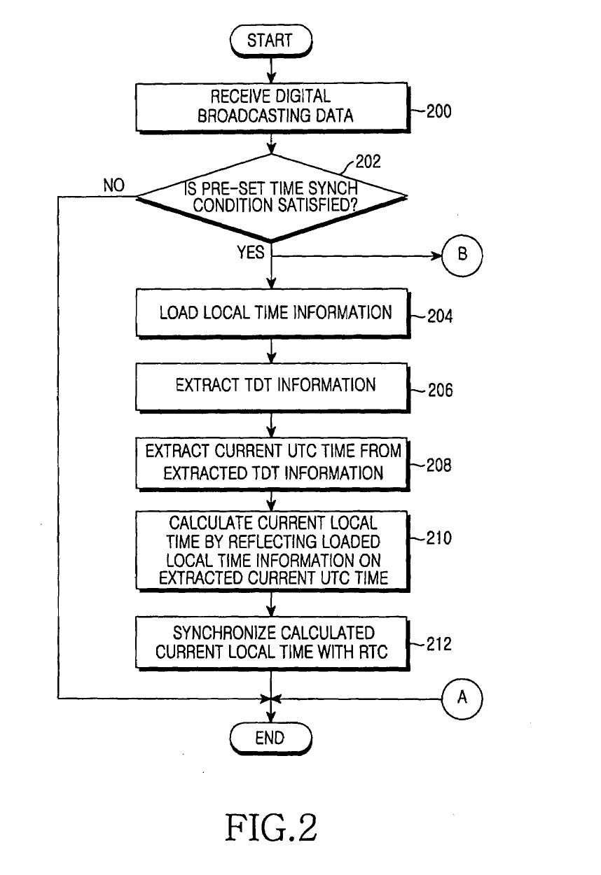

FIG. 2 is a flowchart illustrating a method of performing time synchronization in a digital broadcasting receiving terminal according to of the present invention. Referring to FIG. 2, if digital broadcasting data begins to be received in step 200, the controller 100 of the digital broadcasting receiving terminal determines in step 202 whether pre-set time synchronization condition according to a selection of a user is satisfied. The pre-set time synchronization condition may be satisfied when digital broadcasting data is currently received or when a period set by the user has elapsed. If it is determined in step 202 that the time synchronization condition is satisfied, the controller 100 loads local time information from the memory unit 102 in step 204. If the pre-set time synchronization condition is satisfied when digital broadcasting data is currently received, the controller 100 directly loads the local time information from the memory unit 102 in step 204 without performing the determination of step 202 by determining in step 200 that the pre-set time synchronization condition has been satisfied.

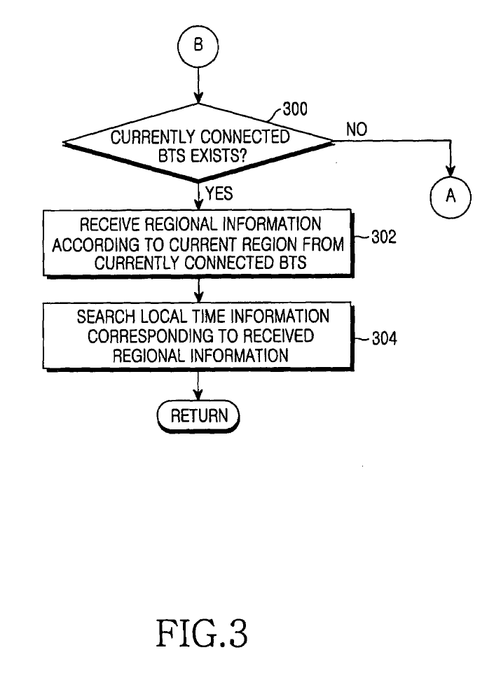

The local time information may be time information of one region or one of a plurality of pieces of time information according to regions, which is (are) stored in the local time information storage unit 126. If the plurality of pieces of time information according to regions are stored in the local time information storage unit 126, the controller 100 receives regional information from a currently connected asynchronous mobile communication network and loads local time information corresponding to the received regional information in step 204. A process of selecting one of the plurality of pieces of time information according to regions in the controller 100 is described in detail with reference to FIG. 3.

The controller 100 determines whether PSI/SI has been received from among the received digital broadcasting data. If it is determined that PSI/SI has been received, the controller 100 extracts TDT information from the received PSI/SI in step 206. The controller 100 calculates a current UTC time using the extracted TDT information in step 208. The controller 100 calculates a current local time in step 210 by reflecting the local time information loaded in step 204 on the calculated current UTC time. The local time information indicates a time difference between the UTC time and each local time according to regions, as described above.

By reflecting the local time information on the calculated current UTC time, the current local time, which is a correct time of a region in which the digital broadcasting receiving terminal is currently located, can be calculated. Thus, when the current local time is calculated, the controller 100 sets an internal time of the digital broadcasting receiving terminal by synchronizing the calculated current local time with the RTC 118 in step 212. Thus, even when the user does not directly set the internal time, the time synchronization according to a region in which the digital broadcasting receiving terminal is currently located is performed using TDT information if the pre-set time synchronization condition is satisfied.

The local time information may be one of the plurality of pieces of time information according to regions, as described above. FIG. 3 is a flowchart illustrating a method used by the controller 100 to select and load time information depending on a currently located region in a digital broadcasting receiving terminal according to the present invention.

Referring to FIG. 3, if it is determined in step 202 of FIG. 2 that the time synchronization condition is satisfied, the controller 100 determines in step 300 whether a currently connected BTS of an asynchronous mobile communication network exists. If it is determined in step 300 that no currently connected BTS exists, the controller 100 determines that the time synchronization cannot be performed and ends the process of performing the time synchronization. However, although no currently connected BTS exists, if any connectable BTS exists, the controller 100 may connect to the connectable BTS.

If it is determined in step 300 that a currently connected BTS exists, the controller 100 receives regional information according to a currently located region from the currently connected BTS in step 302. The controller 100 searches the local time information storage unit 126 for local time information corresponding to the regional information received from the BTS in step 304. The controller 100 returns in 204 and loads the local time information corresponding to the regional information. Thus, the digital broadcasting receiving terminal connected to an asynchronous mobile communication network always can set a correct internal time according to a currently located region.

As described above, according to the present invention, a digital broadcasting receiving terminal connectable to an asynchronous mobile communication network can automatically set a correct time according to a region in which the digital broadcasting receiving terminal is located, even without user's direct setting. Although the controller 100 sets local time information by loading one of a plurality of pre-stored pieces of time information according to regions, which corresponds to a currently located region, as illustrated in FIG. 3, the present invention is not so limited. That is, even if the plurality of pieces of time information according to regions are not stored, the local time information can be modified by downloading regional information according to the currently located region via an asynchronous mobile communication network or replacing a SIM card. Thus, the spirit and scope of the invention is defined by the appended claims.

While the invention has been shown and described with reference to a certain preferred embodiment thereof, it will be understood by those skilled in the art that various changes in form and details may be made therein without departing from the spirit and scope of the invention.

What is claimed is:

1. A time synchronization apparatus of a digital broadcasting receiving terminal connected to an asynchronous mobile communication network, the apparatus comprising:
a Real Time Clock (RTC);
a digital broadcasting receiver for receiving digital broadcasting data and extracting Time and Data Table (TDT) information containing current Universal Time Coordinated (UTC) information from the received digital broadcasting data;
a memory unit for storing local time information, which indicates a difference between current local time of a region where the digital broadcasting receiving terminal is currently located and current UTC time;
a time information calculator for calculating the current UTC time from the TDT information and extracting the current local time of the region in which the digital broadcasting receiving terminal is currently located, by reflecting the local time information on the calculated current UTC time; and
a controller for, if a pre-set time synchronization condition is satisfied, extracting the TDT information through the digital broadcasting receiver, loading the local time information, outputting the loaded local time information and the extracted TDT information to the time information calculator, and, if the current local time is extracted, synchronizing the extracted current local time with the RTC.

2. The apparatus of claim 1, wherein the controller receives the local time information from a currently connected Base Transceiver Station (BTS) of the asynchronous mobile communication network and stores the received local time information.

3. The apparatus of claim 1, wherein the local time information indicates a time difference according to each region and is one of a plurality of pieces of time information according to regions, which are time differences between the UTC time and local times according to regions.

4. The apparatus of claim 3, wherein the controller selects one of the plurality of pieces of time information according to regions, which corresponds to the region where the digital broadcasting receiving terminal is currently located.

5. The apparatus of claim 4, wherein the controller receives regional information according to the region where the digital broadcasting receiving terminal is currently located, wherein the received information is from the currently connected BTS of the asynchronous mobile communication network, and the controller selects one of the plurality of pieces of time information according to the received regional information.

6. The apparatus of claim 5, wherein the regional information is stored in a Subscriber Identity Module (SIM) card of the digital broadcasting receiving terminal.

7. The apparatus of claim 1, wherein the pre-set time synchronization condition is satisfied when the digital broadcasting data can be received or when a period pre-set by a user has elapsed.

8. A time synchronization method of a digital broadcasting receiving terminal connected to an asynchronous mobile communication network, the method comprising the steps of:
receiving digital broadcasting data;
determining whether a pre-set time synchronization condition is satisfied;
if the time synchronization condition is satisfied, loading local time information, which indicates a difference between current Universal Time Coordinated (UTC) time and current local time of a region where the digital broadcasting receiving terminal is currently located;
extracting Time and Data Table (TDT) information containing the UTC information from the received digital broadcasting data;
calculating the current UTC time from the extracted TDT information;
calculating the current local time of the region in which the digital broadcasting receiving terminal is currently located, by reflecting the local time information on the calculated current UTC time; and
synchronizing the extracted current local time with a Real Time Clock (RTC) of the digital broadcasting receiving terminal.

9. The method of claim 8, wherein the pre-set time synchronization condition is satisfied when the digital broadcasting data can be received or when a period pre-set by a user has elapsed.

10. The method of claim 8, wherein the step of loading local time information comprises:
downloading the local time information from a currently connected asynchronous mobile communication network; and
loading the downloaded local time information.

11. The method of claim 8, wherein the step of loading local time information comprises:
loading regional information according to the region where the digital broadcasting receiving terminal is currently located;
selecting local time information corresponding to the loaded regional information from among a plurality of pieces of time information according to regions, which are time differences between the UTC time and local times according to regions; and
loading the selected local time information.

12. The method of claim 11, wherein the step of loading regional information comprises:
downloading the regional information from a currently connected asynchronous mobile communication network; and
loading the downloaded regional information.
